(19) United States
(12) Patent Application Publication
(10) Pub. No.: US 2010/0047145 A1
(43) Pub. Date: Feb. 25, 2010

(54) Systems And Methods For Removing Contaminants From Fluid Streams

(75) Inventors: Wenhua Jiang, Ithaca, NY (US); Yi Jiang, Horseheads, NY (US); Ameya Joshi, Painted Post, NY (US)

Correspondence Address: CORNING INCORPORATED, SP-TI-3-1, CORNING, NY, 14831, US

(73) Assignee: CORNING INCORPORATED, Corning, NY (US)

(21) Appl. No.: 12/195,696

(22) Filed: Aug. 21, 2008

(51) Int. Cl. B01D 53/86; C02F 1/00

(52) U.S. Cl. 423/215.5; 422/171; 210/749

(57) ABSTRACT

A system for contaminant removal from a fluid stream comprises a plurality of flow through reactors arranged in stages that are spaced apart from one another, each reactor comprising at least one flow-through monolith configured to react with at least one contaminant in a fluid stream, and a flow control system configured to selectively control through which of the plurality of flow-through reactor stages a fluid stream containing at least one contaminant may pass.

### TECHNICAL FIELD

The present teachings relate to methods and systems for removing contaminants from fluid streams. In particular, the present teachings relate to methods and systems that utilize flow-through reactors to remove a contaminant from a fluid stream.

### BACKGROUND

Hazardous contaminant emissions have become environmental issues of increasing concern because of the potential dangers posed to human health. For instance, coal-fired power plants and medical waste incineration are major sources of human activity related to emission of contaminants into the atmosphere.

Flow-through monolithic reactors may be utilized to achieve high removal levels of contaminants from fluid streams. A need still exists, however, for more effective utilization of such flow-through reactors, particularly in the context of system level designs. More specifically, it may be desirable to enhance or optimize operation conditions of a contaminant capture system incorporating flow-through reactors to control contaminant emissions in a cost-effective manner.

### BRIEF DESCRIPTION OF THE DRAWINGS

The invention can be understood from the following detailed description either alone or together with the accompanying drawings. The drawings are included to provide a further understanding of the invention, and are incorporated in and constitute a part of this specification. The drawings illustrate one or more embodiments of the invention and together with the description serve to explain the principles and operation.

FIG. 1 is a perspective view of an exemplary embodiment of a flow-through monolith in accordance with the present teachings.

FIG. 2 shows results obtained from a simulation model of the relationship of capacity of an exemplary flow-through reactor as a function of contaminant concentration.

FIG. 3 shows results obtained from a simulation model of contaminant removal efficiency as a function of time for various space velocities.

FIG. 4 shows results obtained from a simulation model of contaminant removal efficiency as a function of time corresponding to various exemplary flow-through monolithic reactor configurations.

FIG. 4A shows the results from the portion 4A of FIG. 4.

FIG. 5 shows results obtained from a simulation model of degree of saturation versus position along a length L of a flow-through reactor, the length L dimension being depicted in the exemplary embodiment of FIG. 1.

FIG. 6 is a schematic cross-sectional view of an exemplary embodiment of a multi-stage reactor system for removing contaminants from a fluid stream in accordance with the present teachings.

FIGS. 7A and 7B show two exemplary operational modes of the system of FIG. 6.

FIG. 8 shows results obtained from a simulation model of removal efficiency versus time for various flow-through monolithic reactor systems.

FIG. 9 shows results obtained from a simulation model of degree of saturation as a function of position on a length L of a flow-through monolithic reactor system.

### DESCRIPTION OF EXEMPLARY EMBODIMENTS

In accordance with one exemplary embodiment, the present teachings provide a system for contaminant removal from a fluid stream that comprises a plurality of flow through reactors arranged in stages that are spaced apart from one another, each reactor comprising at least one flow-through monolith configured to react with at least one contaminant in a fluid stream, and a flow control system configured to selectively control through which of the plurality of flow-through reactor stages a fluid stream containing at least one contaminant may pass.

In accordance with another exemplary embodiment, the present teachings provide a method for contaminant removal from a fluid stream comprising directing a fluid stream containing a contaminant to a treatment area comprising a plurality of flow-through reactors arranged in spaced-apart stages, each reactor comprising at least one flow-through monolith configured to react with at least one contaminant in the fluid stream. The method further comprises selectively controlling through which of the plurality of flow-through reactor stages the fluid stream containing the at least one trace contaminant passes.

The exemplary embodiments mentioned above and described herein represent system configurations and operation approaches that can allow for optimization of high removal efficiency of a contaminant, while providing operational flexibility, reduction in operating and/or capital costs, and/or maximizing removal capacity per reactor volume.

When choosing system configurations and/or operational conditions, the present teachings contemplate considering and utilizing various positive performance characteristics of flow-through reactors in contaminant removal. By way of example, the positive performance characteristics taken into consideration may include space velocity (or residence time) effects, entry-flow distribution effects, and/or inlet concentration effects and how those effects impact species mass transport and utilization of the reacting surface of a flow-through reactor with a high removal efficiency (e.g. 90+%), to enhance contaminant removal.

As used herein, the term “reactor” refers to a structure which is capable of removing a contaminant from a fluid stream in contact with the structure. This removal of the contaminant from the fluid stream is often referred to herein as “sorption” of the contaminant onto the reactor structure. Sorption may be facilitated by the presence of chemical agents in or on the reactor structure. Such agents may themselves react with the contaminant, may facilitate the reaction of the contaminant with other material in the reactor structure, or may otherwise facilitate the sorption of the contaminant onto the reactor by any other mechanism. Reference to “removal” of the contaminant from the fluid stream and the “sorption” of the contaminant onto the reactor includes complete removal or sorption of the contaminant, but also includes partial removal or sorption of a contaminant to any extent such as, for example, removal or sorption of 50%, 60%, 70%, 80%, 90%, or 95% or more of the contaminant from a fluid stream.

The terms “sorb,” “sorption,” and “sorbed,” refer to the adsorption, absorption, or other capture of a contaminant on the reactor, either physically, chemically, or both physically and chemically.

As used herein, the term “flow-through reactor” refers to a reactor comprising either a single flow-through monolith or a plurality of such monoliths placed together in a series substantially end to end such that fluid flows through cells of one or more flow-through monoliths from a first end of the reactor to a second end of the reactor. A flow-through reactor may also include a plurality of flow-through monoliths with some additional structure, such as, for example, filter material, one or more packed layers, etc. between the flow-through monoliths.

The present teachings may apply to the removal of any contaminant from any fluid stream. The fluid stream may be in the form of a gas or a liquid. The gas or liquid may also contain another phase, such as a solid particulate in either a gas or liquid stream, or droplets of liquid in a gas stream. Non-limiting, exemplary gas streams include hydrocarbon gas and liquid streams, aqueous liquid streams, coal combustion flue gases and syngas streams produced in a coal gasification process.

Exemplary contaminants include, for instance, contaminants at 3 wt % or less within the fluid stream, for example at 2 wt % or less, or 1 wt % or less. Contaminants may also include, for instance, contaminants at 10,000 μg/m³ or less within the fluid stream. Non-limiting examples of contaminants include metals, including toxic metals. The term “metal” and any reference to a particular metal or other contaminant by name herein includes the elemental forms as well as oxidation states of the metal or other contaminant. Removal of a metal thus includes removal of the elemental form of the metal as well as removal of any organic or inorganic compound or composition comprising the metal.

Non-limiting examples of toxic metals include cadmium, mercury, chromium, lead, barium, beryllium, and chemical compounds or compositions comprising those elements. Other exemplary metallic contaminants include nickel, cobalt, vanadium, zinc, copper, manganese, antimony, silver, and thallium, as well as organic or inorganic compounds or compositions comprising them. Additional contaminants include arsenic and selenium as elements and in any oxidation states, including organic or inorganic compounds or compositions comprising arsenic or selenium. Volatile organic compounds (“VOCs”) are also exemplary contaminants.

The contaminant may be in any phase. Thus, the contaminant may be present, for example, as a liquid in a gas fluid steam, or as a liquid in a liquid fluid stream. The contaminant could alternatively be present as a gas phase contaminant in a gas or liquid fluid stream. In one exemplary embodiment, the contaminant is present in a coal combustion flue gas or syngas stream.

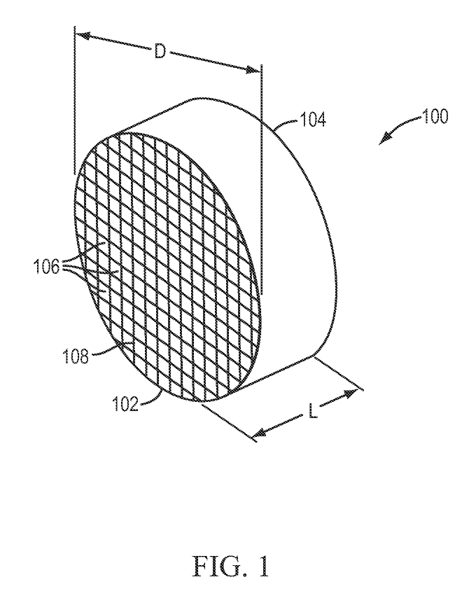

Exemplary flow-through monoliths include, for example, any monolithic structure comprising channels or porous networks or other passages that would permit the flow of a fluid stream through the monolith. FIG. 1 illustrates one exemplary embodiment of a flow-through monolith suitable for the practice of the present teachings. The flow-through monolith 100 shown in FIG. 1 has a length L and a diameter D, an inlet end 102, an outlet end 104, and a multiplicity of cells 106 extending from the inlet end 102 to the outlet end 104. The cells 106 are defined by intersecting (optionally porous) cell walls 108 and form a honeycomb configuration. This and other flow-through monoliths suitable for practice of the present teachings may, for example, have a length ranging from about one inch to greater than one inch, as desired, for example from about one inch to about twelve inches. The flow-through monolith could optionally comprise one or more selectively plugged cell ends to provide a wall flow-through structure that allows for more intimate contact between the fluid stream and cell walls. Also, although a cylindrically shaped flow-through monolith is depicted in FIG. 1, those having skill in the art would understand that such shape is exemplary only and flow-through monoliths in accordance with the present teachings may have a variety of shapes, including, but not limited to, block-shaped, cube-shaped, triangular-shaped, etc.

As will be explained in further detail below, in various exemplary embodiments, multi-staged reactor systems in accordance with the present teachings include a plurality of flow-through reactors arranged in spaced-apart stages to provide greater mixing of the fluid stream, utilize positive performance characteristics associated with the effects of hydrodynamic entry length, contaminant concentration, space velocity, and/or mass species transport on removal efficiency, and/or to provide a decreased pressure drop across the entire series of stages. The space between the flow-through monolithic reactor stages can be of any desirable distance, and in accordance with various exemplary embodiments of the present teachings may be selected to refresh the boundary conditions (e.g., so as to achieve a uniform flow profile) of the fluid stream and/or to permit the introduction of a fresh fluid stream, prior to introducing the fluid stream to a new reactor stage.

As mentioned above, a flow-through reactor stage may optionally include other materials, such as a packed layer, that may provide, for example, added removal of the contaminant from the fluid stream or that may chemically interact with the contaminant in the fluid stream.

The flow-through monoliths used for the reactors of the present teachings may be of any composition, structure, and dimensions suitable for the practice of the invention. For instance, the flow-through monoliths may be formed from compositions disclosed, for example, in U.S. Application Publication Nos. 2007/0261557 and 2007/0265161, or in PCT Application No. PCT/US08/06082, filed on May 13, 2008, the contents of all of which are incorporated by reference herein. The term “monolith” as used herein includes structures such as honeycombs made of, for example, glass, glass-ceramic, or ceramic material, as well as such glass, glass-ceramic, or ceramic material having a coating applied thereto, where the coating may be the same or a different composition.

Any flow-through reactors in accordance with the present teachings can be configured to be non-identical with respect to any one or more physical and/or chemical properties. For example, two or more flow-through reactors can comprise different monolithic structures, different compositions, different cell densities, porous channel walls of differing thickness, and/or cell channels having differing sizes or cross-sectional geometries. Exemplary cell geometries for flow-through monoliths can include circular, square, triangular, rectangular, hexagonal, sinusoidal, or any combination thereof. Further, within a reactor, there may be one or more flow-through monoliths the characteristics of which may be the same or may differ from one another, as described above. If more than one flow-through monolith is used in a reactor, such flow-through monoliths may be positioned such that the cells of one are offset from those of another. Such an arrangement may promote a splitting of fluid streams from the cells of one monolith into two or more cells of another monolith in the reactor.

After a period of use, one or more flow-through monoliths within the multi-stage reactor system may become spent such that they no longer can provide a desired level of removal efficiency for the contaminant. To this end, one or more contaminant detectors or sensors may be positioned anywhere within the system or near or at the outlet end of any reactor stage to detect levels of the contaminant in the fluid stream being processed. The detectors or sensors can provide feedback indicating a concentration of a contaminant in the fluid stream at any given point within the reactor stages or near or at the outlet of a reactor stage.

Accordingly, when the concentration of a contaminant in the fluid stream exceeds a predetermined level, being indicative of a removal efficiency at or below certain standards, one or more flow-through monoliths in a reactor stage may be exchanged, and, using the flexible operation techniques described above, flow may be diverted around such a stage and potentially through a new, fresh stage.

Flow-through monoliths also may be exchanged according to any appropriate time schedule. For instance, such an exchange may be made once a year during a yearly power plant outage for maintenance. Furthermore, the exchange may occur with or without discontinuing the fluid stream flow path through the various reactor stages.

As discussed above, the present teachings contemplate utilizing various positive performance characteristics of flow-through reactors to achieve efficient and effective removal of contaminants in a fluid stream. To utilize those positive performance characteristics, a simulation model for predicting contaminant removal was used to obtain results associated with changing various parameters to observe the effect on the ability of flow-through reactors to remove the contaminant from a fluid stream.

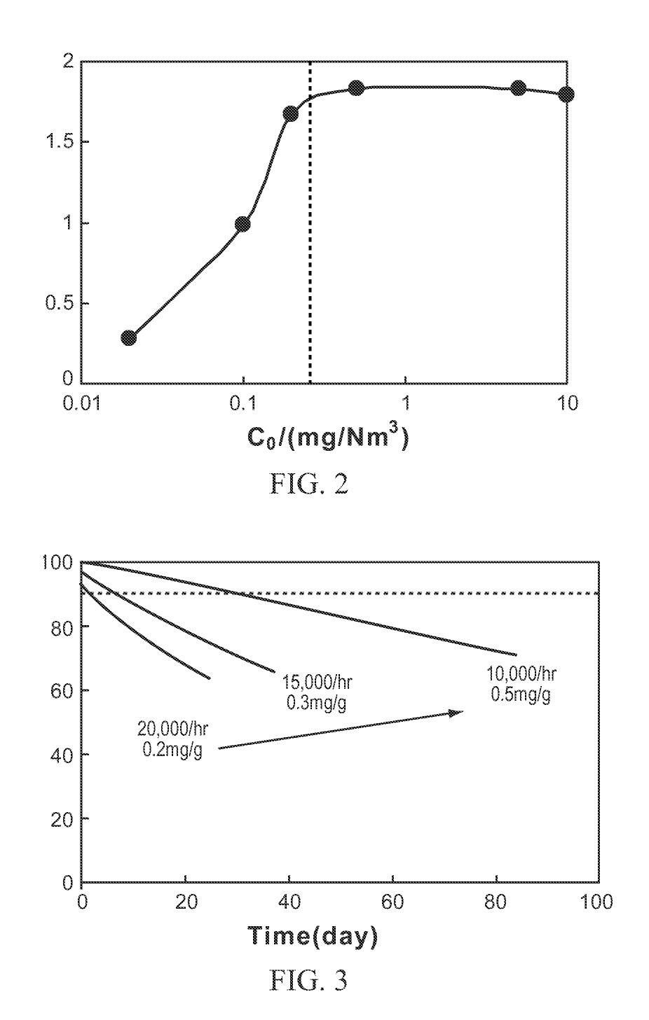

By way of example, in a contaminant removal application, species mass transport characteristics were studied by using the validated model to observe the relationship between removal capacity and inlet contaminant concentrations when using a flow-through monolith. More specifically, FIG. 2 depicts the removal capacity at different inlet contaminant concentrations and under certain operation conditions in one embodiment. As illustrated in FIG. 2, the capture (removal) capacity (in units of milligram of captured contaminant per gram of reactor material) of a single flow-through monolithic reactor R1 decreases as the inlet contaminant concentration decreases. As can be seen from the simulation model results shown in FIG. 2, the capacity was substantially constant and relatively large at a relatively high inlet concentration and decreased relatively rapidly in more dilute inlet concentrations. The results reflect the species mass transport diffusion effect in which a high concentration results in a large capacity due to the increased speed of mass transport.

Another positive performance characteristic of flow-through reactors includes the effect of space velocity on mercury removal efficiency. The space velocity is measured as the volumetric flow rate of the fluid passing through a reactor divided by the reactor volume and represents how many reactor volumes of feed can be processed in a unit of time. The residence time has an inverse relationship to the space velocity. A high space velocity results in a short residence time and vice versa. More specifically, as observed from the simulation model results of FIG. 3, increasing the residence time of a fluid in a reactor leads to an increase in captured contaminant. The results shown in FIG. 3 show that removal efficiency increased with the decrease of the space velocity due to a relatively long residence time associated with a relatively small space velocity. The results of FIG. 3 also demonstrate the diffusion effect of species mass transport on removal performance.

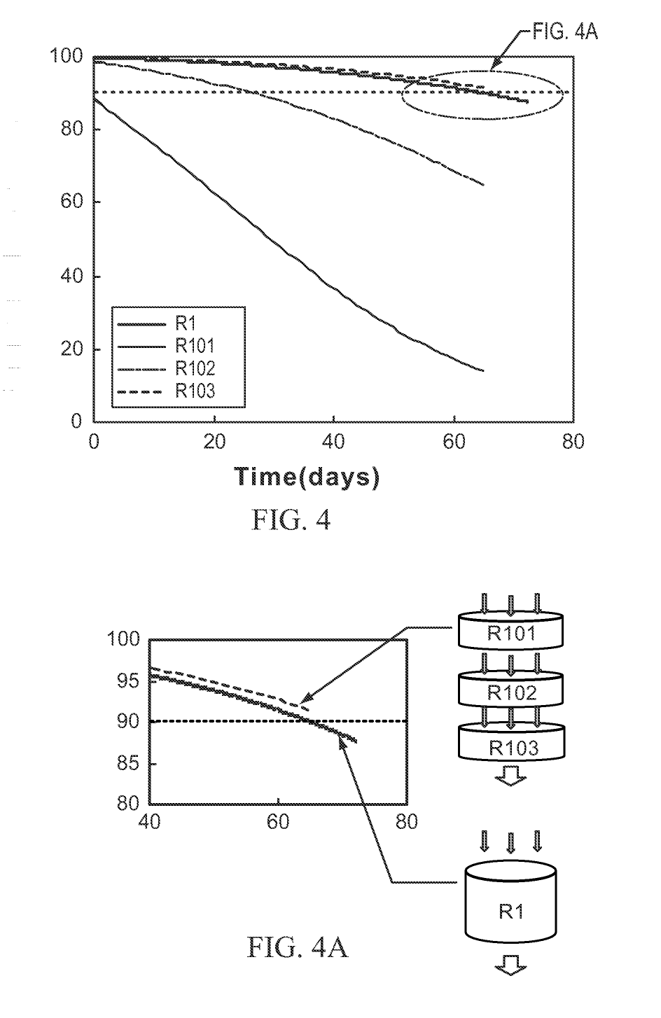

Yet another positive performance characteristic of flow-through monolithic reactors that was considered using the simulation model was the effect of hydrodynamic entry-length on mercury removal. FIGS. 4 and 4A show a comparison of the simulation model predictions using a series of three spaced-apart flow-through reactor stages, R101, R102, and R103, operating in sequence and simulation model results using a single-stage monolithic reactor R1, wherein the three staged reactors combined have a slightly less overall reactive volume than the single reactor R1.

FIGS. 4 and 4A show the change in removal efficiency over a period of time (measured in days on the X-axis). The lower line in FIG. 4 corresponds to the simulation using only reactor R101 for contaminant removal and the second to lowest line corresponds to the simulation using reactors R101 and R102 for contaminant removal. The upper two lines in FIG. 4 and shown in detail in FIG. 4A correspond to the simulation using reactors R101, R102, and R103 in series for contaminant removal (upper line in FIG. 4A) and using reactor R1 for contaminant removal (lower line in FIG. 4A). As best seen in FIG. 4A, according to the simulation model, using the three spaced-apart (staged) reactors R101, R102, and R103 provides slightly better performance than using a single reactor R1 having a slightly greater overall reactive volume.

Without necessarily being bound by the following theory, the inventors believe that the better performance of using the three staged reactors R101, R102, and R103 demonstrated in the results shown in FIGS. 4 and 4A, may be due at least in part to the hydrodynamic entry length effect. More specifically, when a uniform fluid flow (e.g., having a substantially uniform flow profile) enters into a channel, it takes some time to develop to a steady-state flow having a parabolic flow profile. The length along the channel needed for the flow to develop to the parabolic profile is defined as the hydrodynamic entry length. The flow-through reactors R101, R102, and R013 have longer hydrodynamic entry lengths relative to their overall lengths than does the single reactor R1. In other words, a substantially uniform flow profile is maintained over a longer portion of the overall length of reactors R101, R102 and R103 than in the reactor R1. Such a uniform flow profile enhances the mass transport species effect and permits better reaction of mercury as compared to a parabolic flow profile. As such, by spacing apart the three reactors R101, R102, and R103 and permitting the boundary conditions of the flow to be refreshed between each stage, better sorption can be achieved by each due to a substantially uniform flow profile of the flow in the entry region of each reactor.

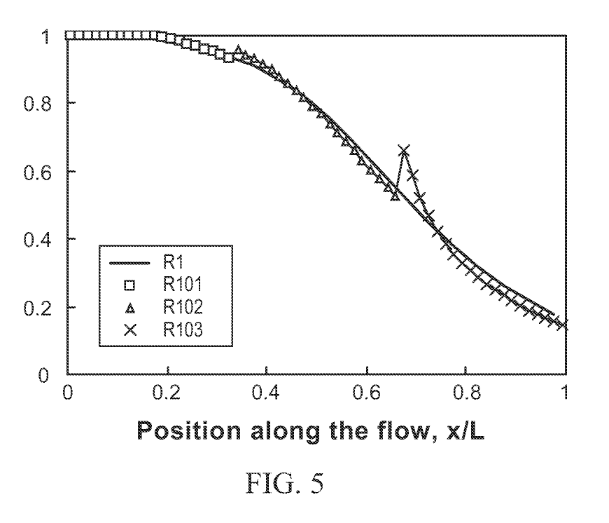

Referring now to FIG. 5, the simulation model was used to compare the degree of saturation of contaminant on the reactive surface along each of R101, R102, R103, and R1 at the time when R1 drops to a removal efficiency of 90%. As can be seen from the results in FIG. 5, the relative flow uniformity at the reactor entrance (i.e., before the flow can develop to a steady-state parabolic flow profile) enables more contaminant capture. In other words, as shown by the results of FIG. 5, there is a relatively high degree of saturation observed near the entry of the reactors as compared to the portions of the reactors' length near their exits. Further, two peaks of contaminant saturation were observed at the entrance of each of the R102 and R103 reactor stages, shown by the triangles and Xs, respectively, in FIG. 5. Without necessarily being bound by the following theory, the inventors believe that these relatively significant degrees of saturation observed at the entrance of each of R102 and R103 may be due to the hydrodynamic entry length effect. That is, as the flow enters each of the reactors R102 and R103, due to the spaced-apart configuration of these reactors, the boundary conditions of the flow can be refreshed and a substantially uniform flow profile can be established in the entrance regions (e.g., over about 3/20 of the length of each reactor). This in turn may permit greater species mass transport of the contaminant to the flow-through monolithic reactors and thus increased saturation.

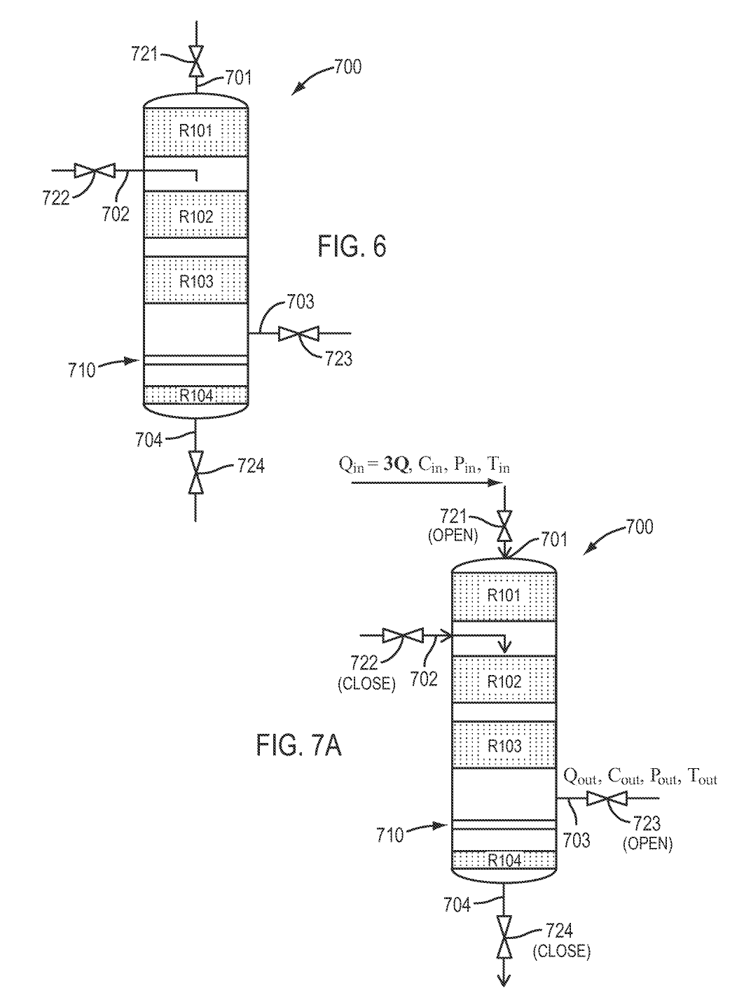

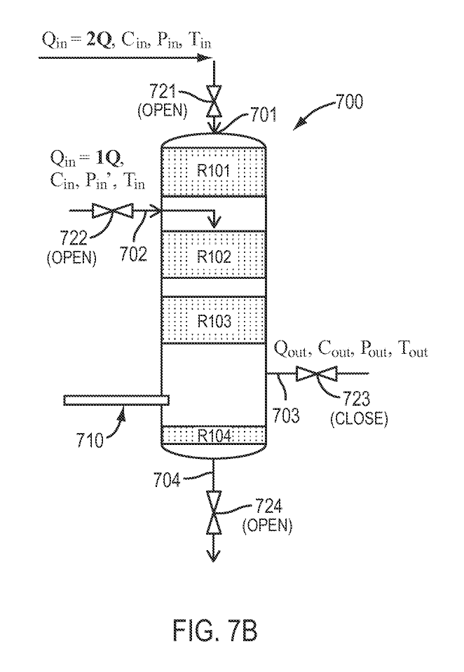

FIG. 6 shows an exemplary embodiment of a system for removing contaminants from a fluid stream that takes into consideration the various positive performance characteristics described above. FIGS. 7A and 7B show exemplary operational modes of the system of FIG. 6. Referring to FIG. 6, the system 700 for removing contaminants from a fluid stream includes an exemplary flow control system, described in more detail below, and a plurality of flow-through reactors R101-R104 disposed in spaced-apart stages. As will be explained, the arrangement of the reactor stages R101-R104 and the components of the flow control system enable the system 700 to be operated in a flexible mode so as to permit control over which reactor stages are utilized during a particular time period and how much fluid is passed through each of the various reactor stages. By configuring a system for removing contaminants from a fluid stream to achieve such operational flexibility, operation of the system can be selected as desired, for example, to optimize contaminant removal in an efficient manner.

In the exemplary embodiment of FIG. 6, the system 700 includes four reactor stages R101, R102, R103, and R104 configured to permit passage of a fluid stream. In the exemplary embodiment of FIG. 6, the direction of fluid flowing through the system is from top to bottom in the orientation of FIG. 6. Each reactor stage R101-R104 includes at least one flow-through monolith configured to react with at least one contaminant in a fluid stream that may pass through the respective reactor stage in order to remove at least some of that contaminant from the fluid stream. Exemplary flow-through monoliths include those disclosed in U.S. Application Publication Nos. 2007/0261557 and 2007/0265161, incorporated by reference herein in their entireties.

In an exemplary embodiment, the flow-through reactors R101-R104 may be spaced apart from each other, for example, in a range from 0.001 inch to 1 inch or more, so as to form reactor stages, and positioned so as to permit, with appropriate flow control devices, a fluid stream to be passed through one or more of the reactor stages in parallel and/or in series. The space between stages R101, R102, R103, and R104 may have no reduction of its diameter; alternatively the space between the stages may be decreased in its diameter, for example, to use a pipe connection (not shown) between stages. The description below will set forth exemplary operations of the system 700 that include flowing the fluid in parallel and in series through various of the reactor stages R101-R104. Positioning the flow-through reactors R101-R104 in a spaced-apart, staged manner may assist in utilizing the hydrodynamic entry length effect to improve contaminant removal. For example, providing space between the flow-through reactor stages may permit the boundary conditions of the fluid flow passing through each stage to be refreshed prior to entering the next reactor stage, which can thereby result in reestablishing a uniform flow profile near the entry region of each reactor stage. For example, for reactor stages R101-R103 each having a length of about ⅓ inch, such a uniform flow profile may be established for up to about 3/20ths of the length of each of the reactors R101-R103. Establishing a substantially uniform profile in each of the reactor stages may increase the overall performance of the system by permitting greater contaminant removal in comparison to a system with a single reactor stage.

The system 700 in the exemplary embodiment of FIG. 6 also includes a flow control system that includes a valved inlet 701 positioned upstream of the first reactor stage R101 in the series of reactors stages R101-R104 and a valved inlet 702 positioned downstream of the first reactor stage R101 and upstream of the rest of the reactor stages R102-R104. The valves 721 and 722 associated with the inlets 701 and 702 permit the amount of flow through each inlet to be controlled, including permitting complete closure of the inlets 701 and 702 to prevent fluid from entering the system 700 through such a closed inlet. The flow control system further includes a valved outlet 704 positioned downstream of the last (e.g., fourth) reactor stage R104 in the series of reactor stages R101-R104 and a valved outlet 703 positioned upstream of the last reactor stage R104 and downstream of the rest of the series of reactor stage R101-R103. As with valves 721 and 722, valves 723 and 724 associated with the outlets 703 and 704 permit the amount of flow through each outlet 703 and 704 to be controlled, including permitting complete closure of the outlets 703 and 704 to prevent fluid from exiting the system 700 through such a closed outlet.

In addition to the valved inlets 701, 702 and outlets 703, 704, the flow control system may include a movable plate 710. In the exemplary system 700 of FIG. 6, the movable plate 710 is disposed between the reactor stages R103 and R104. Moving the movable plate between an open position (shown in FIG. 7B) and a closed position (shown in FIGS. 6 and 7A) controls whether or not fluid containing a contaminant may pass through the reactor stage R104. For example, when the movable plate 710 is in a closed position, as depicted in FIGS. 6 and 7A, it serves to block fluid from upstream of the movable plate 710 (e.g., fluid leaving the reactor stage R103) from entering and passing through the reactor stage R104. Moving the movable plate 710 to an open position, as depicted in FIG. 7B, will permit the fluid leaving reactor stage R103 to flow through the reactor stage R104.

In various exemplary embodiments, a movable plate or other similar flow control mechanism that can selectively block fluid as it flows through the series of reactors stages may be used to entirely block the flow of fluid to a reactor stage, such as, for example, the reactor stage R104 in the exemplary embodiment of FIG. 6. As such, that reactor stage may serve as a fresh reactor to be selectively utilized during a period of operation of the system as desired, for example, during servicing and/or maintenance of another of the reactor stages and/or when an additional reactor is needed due to saturation of one or more of the rest of the reactor stages.

Referring now to FIGS. 7A and 7B, two different modes of operating the system 700 for removing one or more types of contaminants from a fluid stream will now be described. In FIGS. 7A and 7B, the variable Q represents the fluid stream flow rate, the variable C represents the fluid stream contaminant concentration, the variable P represents the fluid stream pressure, and the variable T represents the fluid stream temperature. The subscripts “in” and “out” represent the fluid stream inlet and outlet conditions, respectively. In the operational mode shown in FIG. 7A, the valves 721 and 723 are open, the valves 722 and 724 are closed, and the movable plate 710 is in a closed position to block the fluid flowing through the reactor stages R101-R103 from entering into reactor stage R104. A fluid stream may be introduced to the system 700 through the inlet 701 with the valve 721 in the open position. The fluid stream entering inlet 701 may pass through the reactor stages R101, R102, and R103, and then may exit the system 700 through the outlet 703, with the valve 723 in an open position. In the operational mode depicted in FIG. 7A, therefore, the staged reactors R101, R102, R103 operate in sequence, with the fluid flow that enters the system 700 via inlet 701 flowing in series through the reactor stages R101-R103, and exiting the system 700 via outlet 703. In addition, in the exemplary operational mode shown in FIG. 7A, since the movable plate 710 is in the closed position, none of the fluid entering the system 700 flows to or through reactor stage R104.

With reference now to FIG. 7B, another exemplary operational mode of the system 700 is illustrated. In the operational mode of FIG. 7B, valves 721, 722, and 724 are open, valve 723 is closed, and movable plate 710 is in the open position to permit fluid to flow to and through reactor stage R104. In this operational configuration, a fluid stream, such as, for example, a flue gas stream from a coal-fired power plant, may be introduced to the system 700 through both inlets 701 and 702, with the valves 721 and 722 in the open position. As such, the fluid stream from the power plant may be split into separate portions flowing in parallel to enter the system 700. For example, in the exemplary operational mode of FIG. 7B, a portion of the fluid stream may enter the system via inlet 701 upstream of reactor stage R101 and another portion of the fluid stream may enter the system 700 via inlet 702, bypassing reactor stage R101 and entering upstream of reactor stage R102. The two parallel-flowing portions of the fluid stream are remixed with each other upstream of reactor stage R102 such that the whole fluid stream flows in series through reactor stages R102, R103 and R104, with the movable plate 710 in the open position. After flowing through reactor stage R104, the fluid stream exits the system at outlet 704.

In the operational mode depicted in FIG. 7B, therefore, less of the fluid stream may be introduced into reactor stage R101, which may be beneficial if, for example, it is desired to reduce the load on that reactor, which, due to its first position in the series of reactor stages may have a tendency to become saturated more quickly. Moreover, splitting the entering flue gas stream may serve to increase the contaminant concentration of the combined flow which enters reactor stage R102. That is, the untreated portion of the flue gas stream entering through inlet 702 may increase the concentration of the combined fluid stream that enters reactor stage R102, as compared to if the entire flue gas stream were introduced into reactor stage R102 after passing through reactor stage R101. As discussed above with reference to FIG. 2, increasing the concentration increases the removal capacity of the reactor R102, and thus the overall system.

In addition, in the exemplary operational mode shown in FIG. 7B, with the movable plate 710 in the open position, fluid entering the system 700 flows through reactor stage R104, which may be a relatively fresh reactor if the movable plate 710 was previously closed during operation of the system 700, as shown, for example, in the operational mode of FIG. 7A. The ability to selectively utilize reactor stage R104, which may be fresh, may increase the contaminant removal capacity and efficiency of the overall system 700 without needing to shut down the system 700, for example, to replace reactors and/or otherwise service the system 700.

Those having ordinary skill in the art would understand that the operational modes shown and described with reference to FIGS. 7A and 7B are exemplary only and not intended to be limiting of the scope of the present teachings or claims. Indeed, it is envisioned that the various exemplary valves 721, 722, 723, and 724 may be open or closed as desired to control the fluid flow through the respective exemplary inlets 701 and 702 and exemplary outlets 703 and 704 associated with those valves and/or the degree to which the valves 721, 722, 723, and 724 are opened may be selected as desired to control the amount of flow (including the relative amounts of flow) flowing through the respective inlets 701 and 702 and outlets 703 and 704. Thus, valves 721, 722, 723, and 724, and movable plate 710 may be configured to allow selective control over the flow of the fluid entering the system 700, including control over through which of the reactor stages R101, R102, R103, and R104 fluid may pass and/or control over which portions of a fluid stream directed to the system 700 pass through a particular reactor stage R101, R102, R103, or R104 (e.g., control over the amount of fluid flowing through a particular reactor stage).

Moreover, those having ordinary skill in the art will understand that the configuration of the system 700 depicted in FIG. 6 is exemplary only and not intended to be limiting of the present teachings or claims. Accordingly, systems for removing contaminants from a fluid stream in accordance with the present teachings may include a plurality of spaced-apart reactor stages and that plurality may include any number, with the four reactor stages of FIG. 6 being exemplary only. Further, multi-staged reactor systems in accordance with the present teachings may include flow control systems comprising a variety of flow control mechanisms, including but not limited to, for example, conduits, valves, inlets, outlets, diaphragms, throttles, nozzles, movable plates, or combinations thereof, arranged and configured to permit selective control over relative flow rates of fluid streams entering to the reactor stages and/or selective control over flow paths of a fluid stream (including diverting flow paths, separating a single flow path into multiple flow paths, and combining multiple flow paths into a single flow path) to permit control over which of a plurality of reactor stages a fluid flow in the system may pass and how much fluid may flow through any particular reactor stage.

Other characteristics of systems of the present teachings also may be altered as desired including the spacing between consecutive reactor stages, the materials used for the flow-through monoliths in each stage, the overall configuration (e.g., dimensions, shapes, pore sizes, porosity, cell wall thickness, etc.) of the flow-through monoliths used in a system, and/or properties of the fluid stream entering the system, such as, for example, temperature, pressure, concentration of contaminants and/or other substances in the fluid, and flow rate (both into, through and out of the system). Ordinarily skilled artisans will understand that based on various parameters of the overall system operation and of the fluid stream for which treatment is desired, at least some of the various characteristics and features described above may be selected so as to optimize the contaminant removal efficiency. For example, based on the present teachings, skilled artisans may consider such factors as the hydrodynamic entry length effect, the effect of concentration on the ability of flow-through monolith reactors to remove low levels of contaminants from a fluid stream, and/or the space velocity effect when determining a configuration and operation of the overall system so as to optimize contaminant removal, including, for example, achieving a 90% or greater contaminant removal efficiency.

Simulation models were run to compare the removal efficiency of using a single flow-through monolithic reactor stage versus using the plural flow-through monolithic reactor stages of the exemplary system of FIG. 6 in two operational modes during two time periods to remove a contaminant from a fluid stream. In particular, when running the simulation model for the system of FIG. 6, the operational parameters were altered to reflect the operational mode described with reference to FIG. 7A for a first period of time (i.e., for about 65 days) (Period I) and the parameters were then switched to reflect the operational mode described with reference to FIG. 7B for a second period of time (i.e., from day 66 through day 76) (Period II).

For Period I, the entire flow (e.g., 3Q in FIG. 7A) was directed through the inlet 701, through reactor stages R101, R102, and R103, and then through outlet 703. For Period II, the total flow rate was maintained with ⅔ of that flow (e.g., 2Q in FIG. 7B) entering the system via inlet 701 and ⅓ of that flow (e.g. 1Q in FIG. 7B) entering the system via inlet 702 (i.e., reactor stages R101 and R102 were operated in parallel). Also, for Period II, the movable plate 710 also was moved to the open position, the valve 723 was closed, and the valve 724 was opened to permit the fluid to flow through reactor stage R104.

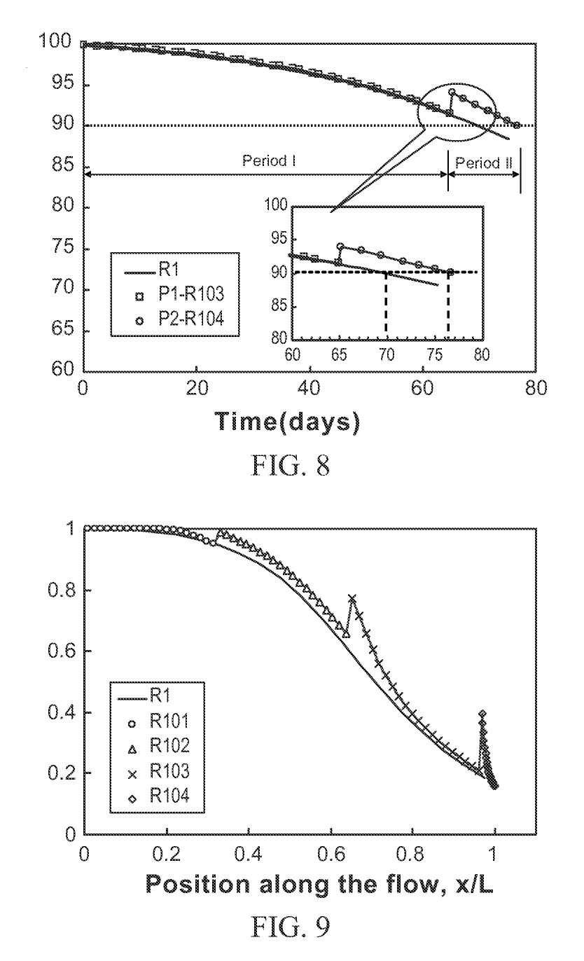

FIG. 8 shows the simulation results of using the multi-staged reactor system of FIG. 6 with the operation modes described above during the two time periods (Period I and Period II) and the simulation results of using a single flow-through reactor stage (having the same configuration as R1 described above with reference to FIGS. 4 and 4A) operated at the same overall flow rate over the total period of time of Period I and Period II. The simulation results of FIG. 8 show that the multi-stage flow-through reactor system operated in two different modes during Period I and Period II, as described above, has an overall better performance in removal efficiency and capacity. In particular, during Period II, the multi-staged reactor system (results are shown by lines with circles) showed enhanced performance in comparison to the single reactor stage (results shown by solid line), achieving about a 10% increase in adsorption time at 90% removal efficiency or greater, 7 days out of the 76-day overall period shown, which results in more than a 10% increase in removal capacity. Although the total reaction volume of R101, R102, and R103 is slightly less than that of the single reactor stage R1 (a difference in the size of R104), it is believed the hydrodynamic entry length effect causes the use of the three reactors R101, R102, and R103 in separated stages to have substantially the same removal performance as use of the single reactor stage R1, as can be seen by the solid curve and the curve with squares in FIG. 8.

In Period II, the spike in removal efficiency performance in FIG. 8 is due to the addition of the use of the fresh R104 reactor. The inventors attribute the spike to the substantially uniform inlet flow of the R104 reactor, which enhances the overall capacity of the multi-stage reactor system.

The improvement of contaminant capture when using the multi-stage reactor system of FIG. 6 also can be seen from the simulation model results shown in FIG. 9. FIG. 9 plots the saturation degree at 90% removal efficiency against the position along the overall reactor system length during Period II in FIG. 8. In FIG. 9, the solid line corresponds to the single stage reactor R1, the line with the squares corresponds to the multi-stage reactor stage R101, the line with the triangles corresponds to the multi-stage reactor stage R102, the line with the Xs corresponds to the multi-stage reactor stage R103, and the line with the diamonds corresponds to the multi-stage reactor stage R104.

In Period II, reactor stage R 01 is essentially used as a pretreatment reactor stage. Reducing the flow rate through the reactor stage R101 increased the residence time through the reactor stage R101 and as a result the contaminant concentration in the flow gas was reduced to some degree. The reduction was somewhat limited, however, because during the second time period the reactor stage R101 was almost saturated. Most of the enhanced mercury capture was observed in reactor stages R102 and R103. Thus, FIG. 9 shows a higher saturation at the positions of the reactor stages R102 and R103 than for corresponding positions along the single-stage reactor R1. At the end of Period I, the removal efficiency at the outlet of the R103 reactor stage drops to almost 90%. After that, the removal efficiency is still relatively high, even though not at 90+% removal efficiency, but the reacting surfaces of reactor stages R101, R102, and R103 are not fully saturated. The addition of reactor stage R104 in Period II results in using the stages R101, R102, and R103 to their maximum saturation, and thus the reactor stage R104 works essentially as a fining treatment of the outlet flue gas.

Thus, the simulation model results shown in FIGS. 8 and 9, demonstrate that enhanced performance for removing contaminant can be achieved by using a multi-stage reactor system, as compared to a single stage reactor system, and operating that multi-stage reactor system in different operational modes during different time periods to best utilize the capacity of the individual reactor stages. Those having ordinary skill in the art would understand that the operating conditions described above and used for the simulation model studies are exemplary only and other operating conditions may be chosen depending on various factors. By way of example only, during the operational mode of the second time period, the relative flow rates entering inlets 701 and 702 respectively may be adjusted, the lengths and number of the different time periods corresponding to different operational modes may be altered, the flow path of the fluid through the system may be altered and differ from those shown in FIGS. 7A and 7B, the number, size, and materials used for the reactor stages and the spacing between them may be modified, etc.

Overall, however, based on the present teachings, those having skill in the art would understand how to modify the configuration and operation of a multi-staged reactor system to achieve desired, and enhanced, contaminant removal performance by utilizing operational flexibility of the overall system and taking into consideration the various positive performance characteristics of flow-through monolith reactors described herein in accordance with the present teachings.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

It should be understood that while the invention has been described in detail with respect to certain exemplary embodiments thereof, it should not be considered limited to such, as numerous modifications are possible without departing from the broad scope of the appended claims.

1. A system for contaminant removal from a fluid stream, the system comprising:
a plurality of flow-through reactors arranged in a series of stages that are spaced apart from one another, each reactor comprising at least one flow-through monolith configured to react with at least one contaminant in a fluid stream; and
a flow control system configured to selectively control through which of the plurality of flow-through reactor stages a fluid stream containing at least one contaminant may pass and to selectively block flow of the fluid stream through at least one flow-through reactor stage during one time period and flow the fluid stream through the at least one reactor stage during another time period.

2. The system of claim 1, wherein the flow control system is configured to separate the fluid stream into a plurality of portions and to flow at least one of the portions so as to bypass at least one of the plurality of reactor stages.

3. The system of claim 2, wherein the flow control system is configured to control a flow rate of the plurality of portions of the fluid stream.

4. The system of claim 1, wherein the flow control system comprises at least one inlet configured to introduce fluid from the fluid stream at a location upstream of the plurality of flow-through reactors and at least one additional inlet configured to introduce fluid from the fluid stream at a location downstream of at least one of the plurality of flow-through reactors.

5. The system of claim 1, wherein the flow control system comprises at least one outlet configured to remove fluid from the fluid stream from a location downstream of the plurality of flow-through reactors and at least one additional outlet configured to remove fluid from the fluid stream from a location upstream of at least one of the plurality of flow-through reactors.

6. The system of claim 1, wherein the flow control system comprises flow control mechanisms chosen from conduits, valves, nozzles, throttles, movable plates, diaphragms, inlets, outlets, and combinations thereof.

7. The system of claim 1, wherein the plurality of flow-through reactors are disposed within a common enclosure.

8. A method for contaminant removal from a fluid stream, the method comprising:
directing a fluid stream containing a contaminant to a treatment area comprising a plurality of flow-through reactors arranged in a series of spaced-apart stages, each reactor comprising at least one flow-through monolith configured to react with at least one contaminant in the fluid stream; and
selectively controlling through which of the plurality of flow-through reactor stages the fluid stream containing the at least one trace contaminant passes, wherein the selectively controlling comprises selectively blocking flow of the fluid stream through at least one flow-through reactor stage during one time period and flowing the fluid stream through the at least one reactor stage during another time period.

9. The method of claim 8, further comprising separating the fluid stream into a plurality of portions and flowing at least one of the portions so as to bypass at least one of the plurality of reactor stages.

10. The method of claim 9, further comprising controlling a flow rate of the plurality of portions of the fluid stream.

11. The method of claim 8, further comprising selectively controlling a location relative to each of the plurality of flow-through reactors at which one or more portions of the fluid stream is introduced to the treatment area.

12. The method of claim 8, further comprising selectively controlling a location relative to each of the plurality of flow-through reactors at which one or more portions of the fluid stream is removed from the treatment area.

13. The method of claim 8, wherein the contaminant is selected from cadmium, mercury, chromium, lead, barium, beryllium, arsenic, and selenium.

14. The method of claim 8, wherein directing the fluid stream comprises directing a fluid stream comprising a fluid selected from coal combustion flue gases and syngases.

15. The method of claim 8, wherein selectively controlling through which of the plurality of flow-through reactor stages the fluid stream containing the at least one contaminant passes comprises flowing a fluid stream entering the treatment area through a first reactor stage and a second reactor stage in series during a first time period and flowing portions of the fluid stream in parallel to enter the treatment area during a second time period such that a portion of the fluid stream flows in series through the first reactor stage and the second reactor stage and another portion of the fluid stream is diverted around the first reactor stage and flows through the second reactor stage.

16. (canceled)

17. The method of claim 8, wherein the at least one reactor stage is a stage disposed downstream of the remaining plurality of reactor stages.

18. The system of claim 1, wherein the plurality of flow-through reactor stages are spaced apart from one another by a distance sufficient to refresh boundary conditions of the fluid stream prior to the fluid stream passing through a respective flow-through reactor stage.

19. The system of claim 1, wherein the plurality of flow-through reactor stages are spaced apart from one another by a distance sufficient to establish a substantially uniform flow profile of the fluid stream entering a respective flow-through reactor stages.

20. The system of claim 19, wherein the uniform flow profile is established from an entry of a respective flow -through reactor stage to a distance of up to about 3/20 of the length of the respective flow-through reactor stage.

21. The system of claim 1, wherein the fluid stream comprises a fluid selected from coal combustion flue gases and syngases.

22. The method of claim 8, further comprising flowing the fluid stream through at least some of the plurality of flow-through reactors and refreshing boundary conditions of the fluid stream prior to the fluid stream entering each of the at least some plurality of flow-through reactors.

23. The method of claim 8, further comprising flowing the fluid stream through at least some of the plurality of flow-through reactors and establishing a substantially uniform flow profile of the fluid stream entering a respective flow-through reactor.

24. The method of claim 23, wherein establishing the substantially uniform flow profile comprises establishing a substantially uniform low profile from an entry of a respective flow-through reactor stage to a distance of up to about 3/20 of the length of the respective flow-through reactor stage.
